(19) United States
(12) Patent Application Publication
(10) Pub. No.: US 2009/0178584 A1
(43) Pub. Date: Jul. 16, 2009

(54) PRINTING MACHINE NIP CHECKING SYSTEM AND PROGRAM

(75) Inventors: Yasuhiro Mochizuki, Tokyo (JP); Hajime Yagi, Tokyo (JP); Yasuhiko Hirata, Tokyo (JP); Kazunori Seto, Tokyo (JP); Yoshiro Matsuura, Tokyo (JP); Takeshi Satoh, Tokyo (JP); Satoshi Morimoto, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: Mitsubishi Heavy Industries, Ltd., Tokyo (JP)

(21) Appl. No.: 12/160,539

(22) PCT Filed: Feb. 26, 2007
(86) PCT No.: PCT/JP2007/053549

§ 371 Date: Jul. 10, 2008

(30) Foreign Application Priority Data
Feb. 27, 2006 (JP) 2006-051074

(51) Int. Cl. B41L 1/02; B41F 33/00

(52) U.S. Cl. 101/481; 101/484

(57) ABSTRACT

An object is to provide a printing machine nip checking system and the like that facilitates a nip checking operation. In the invention, a subject roller selecting section 10 is provided that selects a roller of which a nip width is to be checked. When a subject is narrowed, a main gear rotation angle calculating section 11 determines a rotation angle of the selected roller, in addition to a rotation direction. A main gear rotation driving section 13 connected to the main gear rotation angle calculating section 11 rotates a main gear 18 by the calculated desired angle, after the main gear 18 is stopped for a certain amount of time. As a result, an operator can visually recognize a nip on a subject gear without particularly considering the rotation direction and the rotation angle of the main gear 18.

### RELATED APPLICATIONS

The present application is based on, and claims priority from, International Application PCT/JP2007/053549, filed Feb. 26, 2007, and Japan Application No.2006-051074, filed Feb. 27, 2006 the disclosures of which are hereby incorporated by reference herein in their entirety.

### TECHNICAL FIELD

The present invention relates to a printing machine nip checking system for checking a nip in a roller group and a program allowing nip checking to be performed.

### BACKGROUND ART

In offset printing machines, letterpress printing machines, rotary presses, and other printing machines that print on paper using a large number of rollers, a nip checking operation is conventionally performed to check a width of contact between rollers. Because nip pressure affects printing results, various checking methods have been proposed since the past. However, even when a sensor or the like is used to avoid dependence on skills of an operator, in actuality, problems related to balance with light sources and the like, and to unit prices of devices are present. Therefore, an accurate and easy method is currently being demanded (refer to, for example, Patent Document 1).

Patent Document 1: Japanese Patent Application Laid-open No. 2001-205786

### DISCLOSURE OF INVENTION

### Problem To Be Solved By The Invention

Nip checking naturally involves when a subject roller is rotated in a normal direction and when the subject roller is rotated in an opposite direction. However, it is currently extremely difficult to know in which direction an electric motor itself of a driving source used to operate the subject roller together with a plurality of rollers should be rotated to rotate the subject roller in a desired direction and at a desired angle. A roller group is closely arranged within a printing unit in a complex manner. Therefore, a space through which the subject roller can be visually recognized may be small. The subject roller may be falsely recognized.

The present invention has been achieved in light of the above-described issues. An object of the invention is to provide a printing machine nip checking system that can allow a nip checking operation to be accurately and easily performed and a program allowing a computer to perform the nip checking operation.

### Means For Solving Problem

According to an aspect of the present invention, a printing machine nip checking system includes a subject roller selecting section that selects a roller of which a nip is checked, a main gear rotation angle calculating section that determines a rotation angle of a main gear required to rotate the roller selected by the subject roller selecting section by a predetermined angle, and a main gear rotation driving section that, after the main gear is stopped for a certain amount of time, rotates the main gear by the angle determined by the main gear rotation angle calculating section.

First, the subject roller selecting section selects a roller on which a nip is to be checked, and a subject is narrowed. When the subject roller is narrowed, an angle facilitating viewing by an operator becomes clear. Therefore, the main gear rotation angle calculating section determines a main gear rotation angle for rotating (turning) the subject roller by the angle. The main gear rotation driving section actually rotates (turnably drives) the main gear by the determined angle. The nip is an indentation of contact between rollers. Therefore, after the main gear is stopped for a certain amount of time to form the indentation, the main gear is rotated by the above-mentioned angle. As a result, the operator can visually recognize the nip on the subject gear without particularly considering the rotation direction and the rotation angle of the main gear.

In the printing machine nip checking system, the main gear rotation angle calculating section may reference an angle table determined in advance and performs calculation.

Generally, a position from which the operator views the roller group to check the nip can be said to determine itself by a posture of the operator, a height of the printing machine, and a shape and a structure of the printing machine. Therefore, a roller rotation position at which the nip can be most easily viewed is determined from a standard eye position of the operator. When an angle by which the roller is rotated to the rotation position is measured in advance, the measured angle is converted to the rotation angle of the main gear and compiled into a table, and the table is referenced, the degree by which and the direction in which the main gear is to be rotated can be judged when the subject roller selecting section decides the subject roller.

The printing machine nip checking system may include a subject electing section that, after the nip on the subject roller is checked, selects whether to perform rotation for allowing the main gear rotation driving section to re-check the nip on the same roller or whether to perform rotation for allowing the main gear rotation driving section to check a nip on a next roller to be checked.

Generally, the nip checking is not completed by being performed on only a single roller. The nip is also generally checked a number of times. Therefore, after the nip is checked once, if a selection can be made whether to repeat the same operation again or to transition the checking operation to a next roller requiring checking, nip checking can be performed smoothly in terms of operation.

The printing machine nip checking system may include an operator assisting section that, in accompaniment with driving by the main gear rotation driving section, transmits to an operator which roller is the subject by audio or by a mechanical operating section display.

The nip checking operation is an operation mainly performed by a user as a part of routine maintenance. Therefore, it is convenient if assistance is provided regarding which roller among a number of rollers requires nip checking, which roller the operator is checking, and the like. In the present invention, information required for nip checking is indicated by audio from the printing machine or a mechanical operating section display.

In the printing machine nip checking system, the main gear rotation driving section may perform rotation-driving sufficient for deleting nips before rotating the main gear by the angle calculated by the main gear rotation angle calculating section.

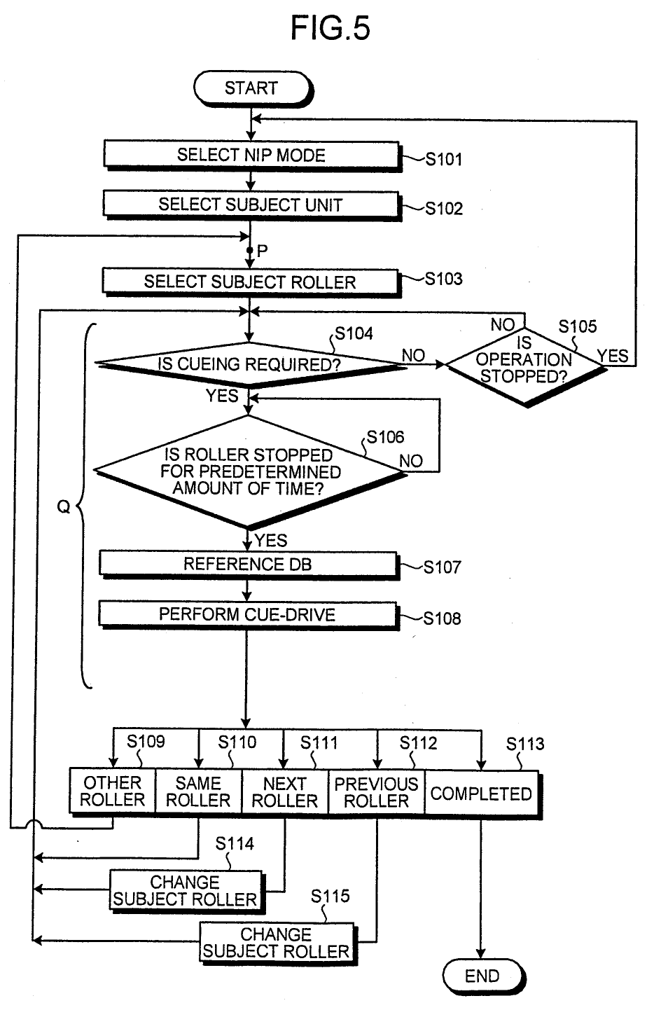

When the nip checking is performed, previously formed nips may interfere with visual recognition. The main gear rotation driving section rotates the roller once or a number of times during cueing and sufficiently deletes the nips, namely history. When the nip on the same roller is checked again at Step S110 in FIG. 5, the nip formed immediately before interferes with the repeated checking operation. Therefore, rotation for deleting the history is preferably performed and the nip checking operation proceeds anew.

The printing machine nip checking system may include a light source provided on a front surface or a back surface of a protective cover, a light irradiation angle calculating section that determines an angle at which light from the light source is irradiated onto a roller position selected by the subject roller selecting section, and a rotation driving section that rotates the light source or a slit provided on a shade of the light source by the angle determined by the light irradiating angle calculating section.

A large number of rollers are provided within the printing unit and are closely arranged. Therefore, depending on the roller, a large area of face is not necessarily exposed to allow nip checking. Moreover, even when the roller requiring checking is known on an information-level, it is difficult to actually know which roller is the subject roller among the roller group. Therefore, in the invention, when the subject roller is selected, a light source illuminates only the roller, thereby facilitating identification of the roller.

According to another aspect of the present invention, a method for checking a printing machine nip includes a subject roller selecting procedure for selecting a roller of which a nip is checked, a main gear rotation angle calculating procedure for determines a rotation angle of a main gear required to rotate the roller selected by the subject roller selecting section by a predetermined angle, and a main gear rotation driving procedure for, after the main gear is stopped for a certain amount of time, rotating the main gear by the angle determined by the main gear rotation angle calculating procedure.

In the method for checking a printing machine nip, the main gear rotation angle calculating procedure may reference an angle table determined in advance and performs calculation.

The method for checking a printing machine nip may include a subject electing procedure for, after the nip on the subject roller is checked, selecting whether to perform rotation for allowing the main gear rotation driving procedure to re-check the nip on the same roller or whether to perform rotation for allowing the main gear rotation driving procedure to check a nip on a next roller to be checked.

In the method for checking a printing machine nip, the main gear rotation driving procedure may perform rotation-driving sufficient for deleting nips before rotating the main gear by the angle calculated by the main gear rotation angle calculating procedure.

### EFFECT OF THE INVENTION

In the printing machine nip checking system of the invention, the nip checking operation is facilitated. Moreover, false recognition of a roller can be prevented. The program of the invention, together with hardware such as a computer, functions as the nip checking system, as a result of the program being loaded into a computer.

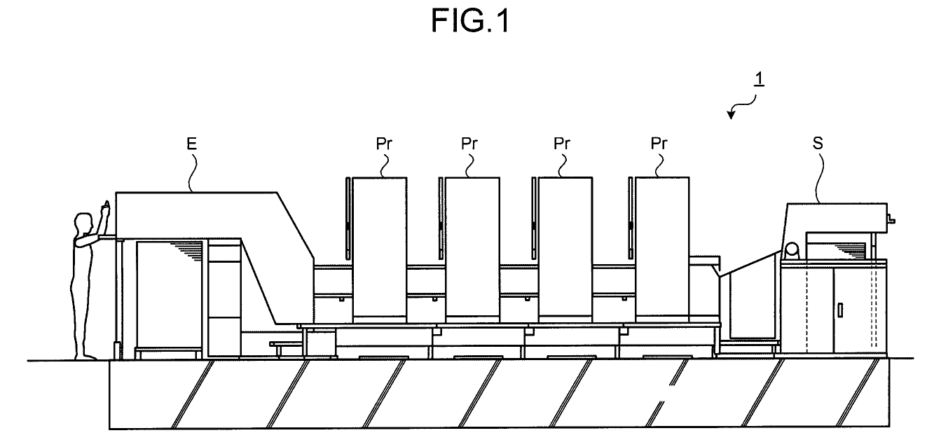

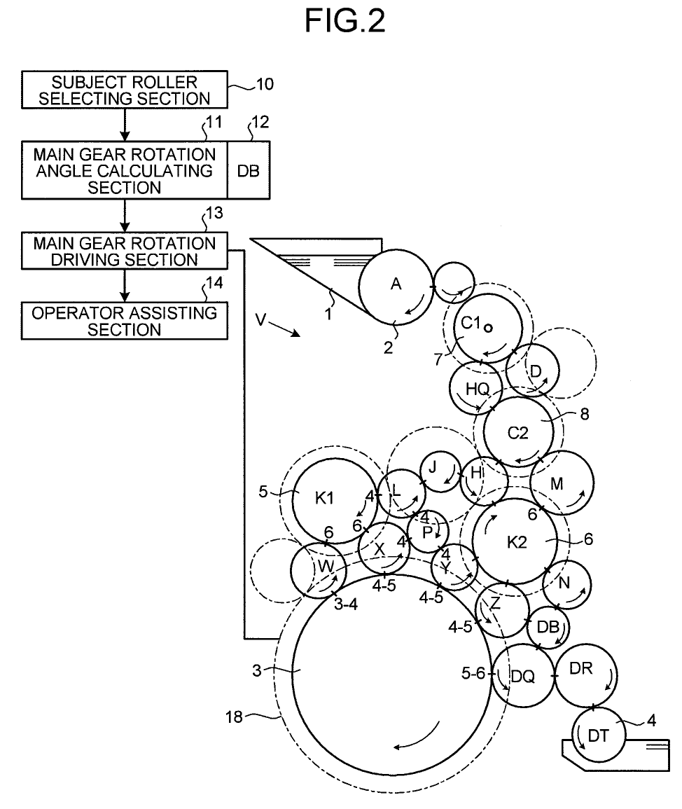

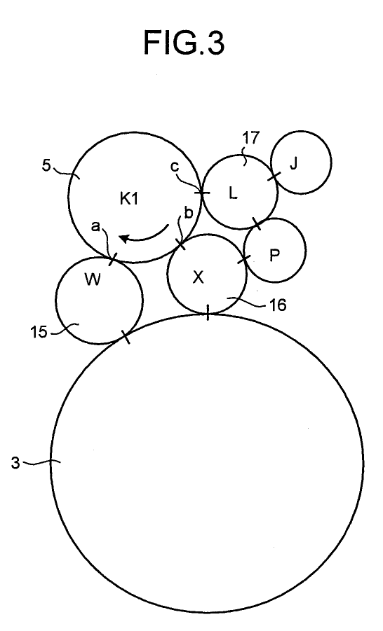

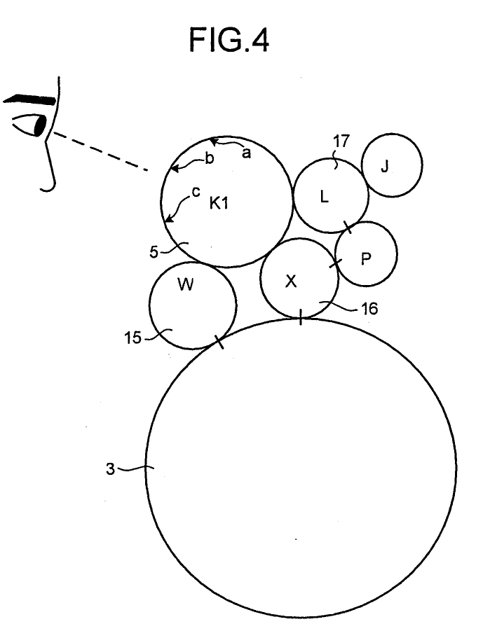

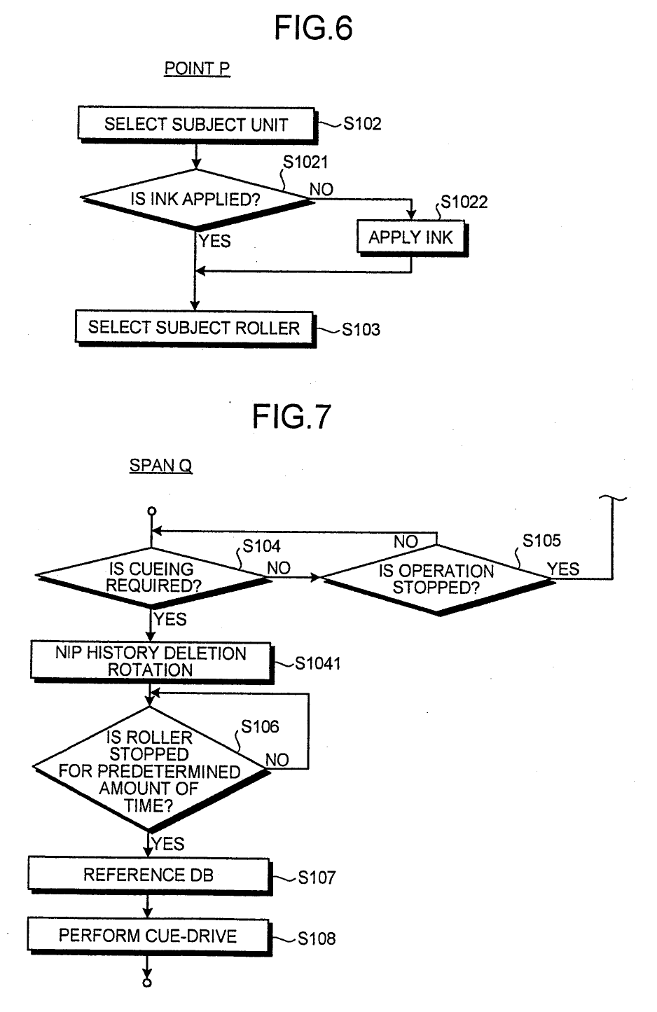

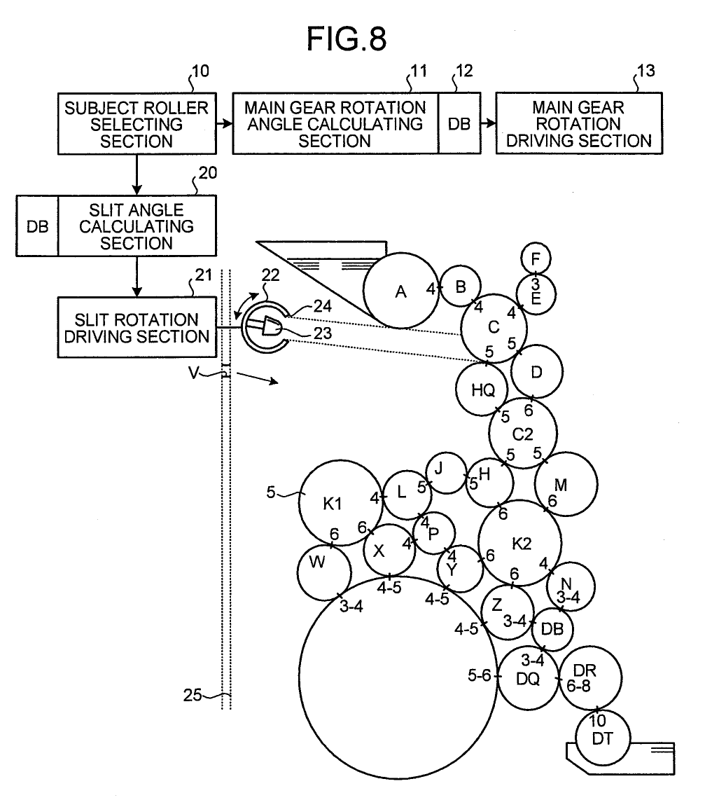

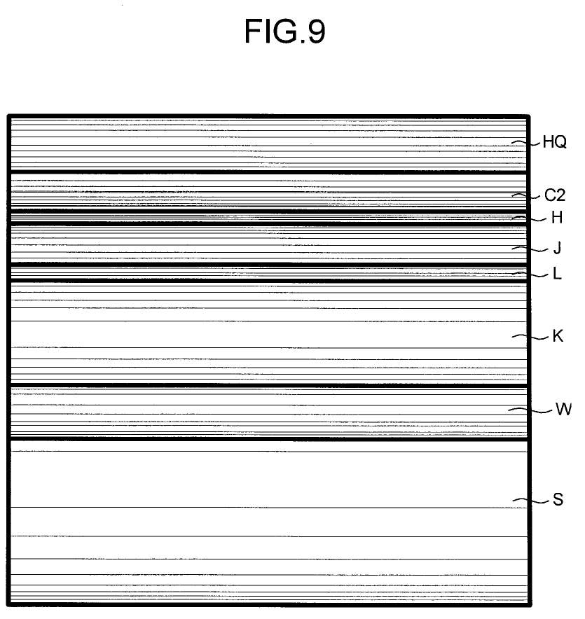

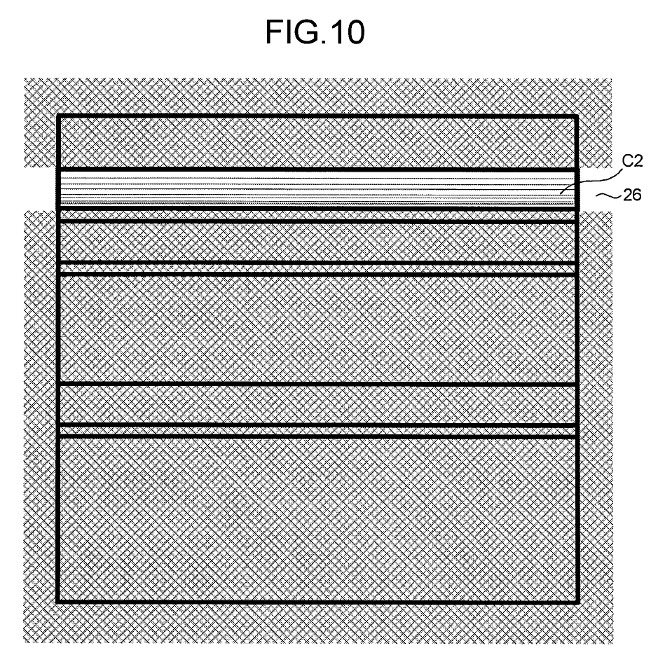

### BRIEF DESCRIPTION OF DRAWINGS

[FIG. 1] Diagram of an outer appearance a configuration of a typical printing machine.

[FIG. 2] Schematic diagram of a configuration of a roller group within a printing unit and a configuration of the present invention.

[FIG. 3] Explanatory diagram of a roller in a rotated state.

[FIG. 4] Explanatory diagram of the roller in a rotated state.

[FIG. 5] Flowchart of operations of the present invention.

[FIG. 6] Flowchart of an example of a configuration allowing an addition at point P in FIG. 5.

[FIG. 7] Flowchart of an example of a configuration allowing an addition within a span Q in FIG. 5.

[FIG. 8] Schematic view of a configuration of an invention using a light source.

[FIG. 9] Diagram of an outer appearance of the roller group viewed from a protective cover.

[FIG. 10] Diagram of an outer appearance in a state in which a roller to be checked is exposed to the light source.

### EXPLANATIONS OF LETTERS OR NUMERALS

1: printing machine

2, 4, 5, 6, 7, 8, 15, 16, and 17: roller

S: paper supplying section

P: printing unit

E: paper ejecting section

10: subject roller selecting section

11: main gear rotation angle calculating section

13: main gear rotation driving section

14: operator assisting section

18: main gear

20: slit angle calculating section

21: slit rotation driving section

22: shade

23: light source

24: slit

25: protective cover

26: spotlight

### BEST MODE(S) FOR CARRYING OUT THE INVENTION

The invention will be described in detail below with reference to the drawings. The invention is not limited by the embodiments. Constituent elements according to the embodiments below include those that can be easily conceived by a person skilled in the art or those that are substantially the same.

### Embodiments

FIG. 1 is a diagram of an outer appearance of a configuration of a typical printing machine. Typically, a printing machine 1 largely includes a paper supplying section S, a printing unit Pr, and a paper emitting section E. The printing unit Pr is provided for each color. For example, when colors used for printing are based on four colors, black (K), cyan (C), magenta (M), and yellow (Y), four printing units Pr are included. When the colors are based on six colors, six printing units Pr are included. When the colors are based on eight colors, eight printing units Pr are included.

FIG. 2 is a schematic diagram of a roller group within the printing unit, and a configuration of the invention. A large number of roller groups used for printing are stored within the printing unit. Largely classified, the rollers are divided into ink rollers and dampening rollers. Specifically, an A roller 2 is an ink fountain roller. A C1 roller 7, a C2 roller 8, a K1 roller 5, and a K2 roller 6 are ink reciprocating rollers. In addition, a D roller, an E roller, an H roller, an M roller, an L roller, an N roller, and an HQ roller are ink milling rollers. A J roller and a P roller are ink millling rollers. A W roller, an X roller, a Y roller, and a Z roller are ink form rollers. A DT roller 4 is a water pan roller. A DR roller is a chrome roller. A DQ roller is a dampening form roller. A DB roller is a delivering roller. In this way, a plurality of rollers are provided depending on function.

The above-described roller group is operated in tandem through a large number of gears shown by dashed lines in the diagram, from a main gear 18 that is one driving source. Alternatively, the roller group is operated in tandem by friction drive between adjacent rollers. In the roller group, the adjacent rollers are in contact. A width of the contact is referred to as a nip width. In other words, a nip is an impression caused by contact. The nip width is required to be an appropriate width to distribute ink, spread ink to an appropriate thickness, and appropriately ensure functions of the rollers. For example, in the diagram, the ink reciprocating roller K1 is designed to appropriately function when nip widths between adjacent W roller, X roller, and L roller are respectively 6, 6, and 4 millimeters.

In the invention, a subject roller selecting section 10 that selects a roller of which the nip width is to be checked is provided. This is because nip checking is performed for each roller to be a subject. Therefore, it is advisable to narrow the subject and determine the subject. When the subject is narrowed, it is clear that a desired angle of a roller, such as a K roller, selected by the subject roller selecting section 10 is preferably rotated by about 90 to 180 degrees, under an assumption that a line of vision of an operator is in a V direction.

Then, when a rotation angle of a “subject roller” is specifically determined as described above, a main gear rotation angle calculating section 11 determines a rotation angle of the “main gear 18” required to perform rotation, in addition to a rotation direction. This can be calculated by a gear ratio of the “subject roller” and the “main gear 18” or a ratio of diameters of adjacent rollers. Alternatively, when values calculated in advance are compiled into a database (DB) as a table, calculation can be further quickened. Therefore, this is preferable.

When the main gear rotation angle calculating section 11 is provided, the angle can be corrected depending on a perspective of the operator. For example, a front surface printing unit and a back surface printing unit are present in a printing machine. Between the front surface printing unit and the back surface printing unit, the perspective of the operator in relation to the roller significantly differs. Even in this case, in the invention, a difference in the perspective can be corrected by a trigonometric function calculation performed by the main gear rotation angle calculating section 11. The angle can also be finely adjusted on-site, because fine adjustment can be easily actualized by a correction value being merely added to or subtracted from the angle determined by the calculating section. The correction value can be entered by an operator panel of the printing unit. The operator panel can be wired or, more preferably, remote-controlled wirelessly.

When the main gear rotation angle calculating section 11 determines the angle, a main gear rotation driving section 13 connected to the main gear rotation angle calculating section 11 rotates the main gear 18 by the desired angle after stopping the main gear 18 for a certain amount of time. The nip is an indentation formed by contact between the rollers. Therefore, to form the indentation, the main gear 18 is required to be stopped for the certain amount of time. As a result, the operator can visually recognize the nip on the subject gear without particularly considering the rotation direction and rotation angle of the main gear 18.

In the invention, an operator assisting section 14 can be provided that, in accompaniment with driving by the main gear rotation driving section 13, transmits information on a position, a state, and the like of the subject roller through audio or a machine operating section display. The nip checking operation is an operation mainly performed by a user as a part of routine maintenance. Therefore, it is convenient if assistance is provided regarding which roller among a number of rollers requires nip checking, which roller the operator is checking, and the like. A machine operating section can be an operating section that oversees an overall printing machine. However, it is more convenient for the operator if the machine operating section is an operating section of the printing unit. The same applies to a speaker that outputs the audio.

FIG. 3 and FIG. 4 are explanatory diagrams of the roller in rotated states. Here, when a roller K1 5 is selected as the subject roller is described. The K1 roller 5 is a reciprocating roller having highly effective ink distribution. Therefore, it is important for the nip width of the K1 roller 5 to be checked. As described above, the K1 roller 5 is connected to a W roller 15, an X roller 16, and an L roller 17. Nip widths a, b, and c between the K1 roller 5 and the rollers 15, 16, and 17 are required to be routinely checked. Therefore, for example, to check a nip width a formed between the K roller 5 and the W roller 15, the K1 roller 15 is rotated in a clockwise direction by about 90 degrees.

When the respective nip widths a, b, and c between the K1 roller 5 and the W roller 15, the K1 roller 5 and the X roller 16, and the K1 roller 5 and the L roller 17 can be simultaneously checked or, in other words, when sufficient visual recognition space to perform the check is provided, all three nips can be simultaneously checked by the K1 roller 5 being rotated in the clockwise direction by about 120 degrees. In this way, depending on the subject roller, the roller may be disposed to allow a plurality of nips to be simultaneously checked. In this case, a rotation angle calculating section performs calculation such that the main gear is rotated by the angle.

TABLE 1

| Roller | | E | B | HR | D | L | X | W | . . . |
|---|---|---|---|---|---|---|---|---|---|
| C1 | R | 20 | 120 | −20 | −110 | — | — | — | — |
| | G | | | | | | | | |
| | [deg] | | | | | | | | |
| | Main | 60 | 360 | −60 | −330 | — | — | — | — |
| | G | | | | | | | | |
| | [deg] | | | | | | | | |
| K1 | R | — | — | — | — | 90 | 180 | −60 | — |
| | G | | | | | | | | |
| | [deg] | | | | | | | | |
| | Main | — | — | — | — | 270 | 540 | −360 | — |
| | G | | | | | | | | |
| | [deg] | | | | | | | | |
| . | | . | . | . | . | . | . | . | . |
| . | | . | . | . | . | . | . | . | . |
| . | | . | . | . | . | . | . | . | . |

Here, determination of a rotation angle of the main gear required to rotate the subject roller such that each nip can be individually viewed will be described with a specific example (see Table 1). For example, the subject roller is C1 roller 7. The C1 roller 7 is in contact with the E roller, the B roller, the HR roller, and the D roller. For example, if the C1 roller 7 that is the subject roller is respectively rotated clockwise by 20 degrees, clockwise by 120 degrees, counter-clockwise by 20 degrees, and counter-clockwise by 110 degrees to allow the nip widths between the subject roller and these rollers to be checked, visual recognition by the operator becomes successful. At this time, a ratio of the main gear 18 to a gear of the subject roller is known (here, 3:1). Therefore, the main gear is merely required to be respectively rotated clockwise by 50 degrees, clockwise by 360 degrees, counter-clockwise by 60 degrees, and counter-clockwise by 330 degrees.

Similarly, for example, the subject roller is the K1 roller 5. The K1 roller 5 is in contact with the W roller, the X roller, and the L roller. If the K1 roller that is the subject roller is respectively rotated clockwise by 90 degrees, clockwise by 180 degrees, and counter-clockwise by 60 degrees to allow the nip widths between the subject roller and these rollers to be checked, visual recognition by the operator becomes successful. At this time, the ratio of the main gear 18 to the gear of the subject roller is known (here, 1:3). Therefore, the main gear 18 is merely required to be respectively rotated clockwise by 270 degrees, clockwise by 540 degrees, and counter-clockwise by 360 degrees.

Generally, a position from which the operator views the roller group to check the nip can be said to determine itself by a posture of the operator, a height of the printing machine, and a shape and a structure of the printing machine. Therefore, a roller rotation position at which the nip can be most easily viewed is determined from a standard eye position of the operator. When an angle by which the roller is rotated to the rotation position is measured in advance, the measured angle is converted to the rotation angle of the main gear and compiled into a table, and the table is referenced, the degree by which and the direction in which the main gear is to be rotated can be judged when the subject roller selecting section decides the subject roller.

FIG. 5 is a flowchart of procedures of the invention. First, in the invention, nip mode that is separate from printing mode originally provided in the printing machine is provided, thereby providing a procedure for selection (Step S101). As a result, a printing operation originally performed by the printing unit is stopped, making it safe for a person performing the nip checking operation. Next, a procedure is provided for selecting a subject unit (Step S102). This indicates that operation has transitioned from that performed by an overall operation panel that oversees a plurality of printing units, in particular, to each printing unit.

Then, a procedure is provided for selecting the subject roller of which the nip is to be checked (Step S103). Next, a procedure is provided for asking the operator whether cueing is required (the operator rotates the roller to a position facilitating viewing) (Step S104). Until a response to the question regarding whether to perform cueing is YES, a loop is formed and the response is awaited. As shown in the diagram, a procedure can be provided for judging whether to stop the nip checking operation during the loop (Step S105).

When the response instructing that the cueing be performed is received, a procedure is provided for asking the operator whether the subject roller is to be stopped for a predetermined amount of time to make the nip width distinct (Step S106). Then, when the subject roller is stopped for the predetermined amount of time, the DB in which the main gear rotation angles are set in advance is referenced (Step S107). In actuality, the invention has a procedure for cueing and rotating the main gear by a computer, an amplifier, an inverter, and an electric motor (Step S108).

After the nip width of the subject roller is checked, a procedure is provide allowing selection of whether the main gear rotation driving section rotates a same roller again to check the nip, whether the main gear rotation driving section rotates a next roller to be checked to check the nip, whether the subject returns to a roller on which the nip check has been previously performed, or whether the subject becomes another roller (Steps S109 to S112). This is because it is not uncommon for the checking operation to be performed on the same roller a plurality of times when the nip width of the same roller is required to be checked again as confirmation.

When the checking operation proceeds smoothly, the operation proceeds to the nip checking of the next roller. The above-described transition step of the subject roller is advantageous in smoothly advancing the operation when a re-checking operation of a previously checked nip is desired. When the next roller is rotated, when the previous roller is rotated, and when another roller is rotated, a procedure is provided to allow the subject roller to be changed (Steps S114, S115, and S103). When the nip checking operation is completed, a procedure is provided that allows completion to be selected (Step S113).

FIG. 6 is a flowchart of an example of a configuration allowing an addition at a point P in FIG. 5. The nip width cannot be successfully checked unless ink is applied to the roller. Therefore, at the point P in the flow in FIG. 5, a procedure is provided for judging whether the ink is applied (Step S1021). When the ink is not applied, an ink dish is filled with ink. Each roller is rotated and the ink is applied (Step S1022). This procedure is advantageous when the nip checking operation is performed before shipment by a manufacturer or when ink-filling performed by a user is insufficient.

FIG. 7 is a flowchart of an example of a configuration allowing an addition within a span Q in FIG. 5. Here, a nip history deleting procedure is a characteristic. The nip history refers to nips on the roller of varying depths. When the nip is checked, a previously formed nip may interfere with visual recognition. In the procedure, when cueing is performed (Step S104), the roller is rotated once or a number of times to sufficiently delete nips, namely history (Step S1041). When the nip on the same roller is checked again in Step S110 in FIG. 5, a nip formed immediately prior to the checking operation interferes with the checking operation. Therefore, it is preferable that the nip checking operation is performed after the roller is rotated to delete the history.

FIG. 8 is a schematic diagram of a configuration of an invention using a light source. A basic configuration including the subject roller selecting section 10, the main gear rotation angle calculating section 11, a database (DB) 12, and the main gear rotation driving section 13 is the same as that shown in FIG. 2. In the invention, when the subject roller to be subjected to the nip checking operation is selected by the subject roller selecting section 10, the subject roller is exposed to a spotlight.

The configuration of the invention includes a light source 23, a slit angle calculating section 20, and a slit rotation driving section 21. The light source 23 is provided on a front side or a back side of the protective cover 25. The slit angle calculating section 20 determines an angle at which light from the light source 23 is irradiated onto the roller position (C2 roller in the diagram) selected by the subject roller selecting section 10. The slit rotation driving section 21 rotates a slit 24 provided on a shade 22 of the light source 23 by only the angle determined by the slit angle calculating section 20. Instead of the slit 24 on the shade 22, the light source 23 itself that has a strong directivity can be rotated and can irradiate light onto the subject roller. At this time, the slit angle calculating section 20 functions as a light irradiation angle calculating section. The slit rotation driving section 21 functions as a rotation driving section of the light source.

A large number of rollers are provided within the printing unit and are closely arranged. Therefore, depending on the roller, a large area of face is not necessarily exposed to allow nip checking. Moreover, even when the roller requiring checking is known on an information-level, it is difficult to actually know which roller is the subject roller among the roller group. Therefore, in the invention, when the subject roller is selected, a light source illuminates only the roller, thereby facilitating identification of the roller. As a result of the roller being exposed to the light source, the nip emerges and visible recognition improves.

FIG. 9 is a diagram of an outer appearance of an example of the roller group viewed from the protective cover. Typically, when the operator views the roller group from the protective cover 25, the roller group appears as shown in the diagram. Here, an example is shown of when the HQ roller to the S roller are viewed from a direction V in FIG. 8. As described above, the rollers are closely arranged. Therefore, it is difficult to know which roller the roller known on an information-level actually is. Therefore, based on electrical information of when the subject roller has been selected, only the position of the roller is exposed to the light source and the subject roller can be clearly visually recognized.

FIG. 10 is a diagram of an outer appearance of a state in which the subject roller is exposed to the light source. As shown in the diagram, the light from the light source is irradiated as the spotlight 26 onto only the position of the C2 roller that is the subject roller. The subject roller can be clearly differentiated from other rollers. When the subject roller is cued in this state, the nip checking operation can be made significantly easier and more accurate. In the configuration in FIG. 8, the slit angle calculating section 20 can research rotation angles decided in advance by the position at which the light source 23 is provided and the position of each roller, and compile the rotation angles into a database (DB) . Alternatively, a servo motor can be used for the rotation of the light source or the rotation of the slit. The angles can be taught manually and stored.

As described above, in the printing machine nip checking system of the invention and the program used to allow a computer to function as the system, the nip checking of the printing machine is facilitated. When the roller to be subjected to the checking is automatically cued, inconvenience of staring at the roller and searching for the nip can be eliminated. When the subject roller is a printing cylinder, there is an advantage in that the nip can be checked while easily avoiding a recess section used to hold a printing plate. Therefore, the nip can be easily checked without the protective cover being opened and the roller being driven. This is extremely important in terms of operational safety. When cueing can be performed by a simple button operation, overall operation time for nip checking a plurality of rollers can be shortened. Moreover, because the light source is advantageously used, the roller to be subjected to the checking can be determined at a glance. The roller can be sufficiently differentiated from the other rollers without the protective cover being opened and is therefore convenient.

A hardware configuration of the printing machine nip checking system of the invention is generally as follows. The configuration centers around a processor, such as a central processing unit (CPU) that is a complex instruction set computer (CISC) or a reduced instruction set computer (RISC), or a digital signal processor (DSP), to which a read-only memory (ROM), a random access memory (RAM), an input and output interface (I/O), and a user interface are connected by a bus. The bus is preferably provided with a serial bus allowing connection with a recording device, such as a hard disk, a magneto-optical, a compact disc-recordable/rewritable (CD-R/RW) drive, and a flexible disk drive, and a recording medium such as a portable volatile memory.

An executable program of the processor is stored in the ROM in advance. In the ROM, a program for communicating with the input and output interface and a program for performing input to and output from the user interface are also stored. The input and output interface is provided with an analog-to-digital converter or a digital-to-analog converter depending on a device connected thereto (a subject roller selecting button, an electric motor driving the main gear, an amplifier or an inverter, a rotary encoder, a light source rotation electric motor, a light source slit rotation electric motor, or an amplifier). Here, explanation has been made under a presumption of digital processing by software. However, the invention can be actualized by analog processing by hardware.

When the subject roller selecting button (regardless of whether the button is hardware or software) is pressed, the main gear rotation angle calculating section reads a main gear rotation angle stored in a storage section constructed by the ROM, the RAM, or a hard disk drive (HDD). Alternatively, the main gear rotation angle calculating section performs calculation on its own. The main gear rotation angle calculating section then outputs an electrical signal corresponding with the angle from the input and output interface to the amplifier. At this time, when an angle feedback from a rotary encoder attached to the electric motor is provided, the electric motor can be more accurately controlled. Angle control of the light source or rotation angle control of the shade on the light source is performed in a similar manner to that described above.

### INDUSTRIAL APPLICABILITY

As described above, the printing machine nip checking system and the program allowing a computer to function as the printing machine nip checking system of the invention are advantageous for routine maintenance of a printing machine.

1. A printing machine nip checking system comprising:
a subject roller selecting section that selects a roller of which a nip is checked;
a main gear rotation angle calculating section that determines a rotation angle of a main gear required to rotate the roller selected by the subject roller selecting section by a predetermined angle; and
a main gear rotation driving section that, after the main gear is stopped for a certain amount of time, rotates the main gear by the angle determined by the main gear rotation angle calculating section.

2. The printing machine nip checking system according to claim 1, wherein
the main gear rotation angle calculating section references an angle table determined in advance and performs calculation.

3. The printing machine nip checking system according to claim 1, further comprising
a subject electing section that, after the nip on the subject roller is checked, selects whether to perform rotation for allowing the main gear rotation driving section to re-check the nip on the same roller or whether to perform rotation for allowing the main gear rotation driving section to check a nip on a next roller to be checked.

4. The printing machine nip checking system according to claim 1, further comprising
an operator assisting section that, in accompaniment with driving by the main gear rotation driving section, transmits to an operator which roller is the subject by audio or by a mechanical operating section display.

5. The printing machine nip checking system according to claim 1, wherein
the main gear rotation driving section performs rotation-driving sufficient for deleting nips before rotating the main gear by the angle calculated by the main gear rotation angle calculating section.

6. The printing machine nip checking system according to claim 1, further comprising:
a light source provided on a front surface or a back surface of a protective cover;
a light irradiation angle calculating section that determines an angle at which light from the light source is irradiated onto a roller position selected by the subject roller selecting section; and
a rotation driving section that rotates the light source or a slit provided on a shade of the light source by the angle determined by the light irradiating angle calculating section.

7. A method for checking a printing nip comprising:
a subject roller selecting procedure for selecting a roller of which a nip is checked;
a main gear rotation angle calculating procedure for determines a rotation angle of a main gear required to rotate the roller selected by the subject roller selecting section by a predetermined angle; and
a main gear rotation driving procedure for, after the main gear is stopped for a certain amount of time, rotating the main gear by the angle determined by the main gear rotation angle calculating procedure.

8. The method for checking a printing machine nip according to claim 7, wherein
the main gear rotation angle calculating procedure references an angle table determined in advance and performs calculation.

9. The method for checking a printing machine nip according to claim 7, further comprising
a subject electing procedure for, after the nip on the subject roller is checked, selecting whether to perform rotation for allowing the main gear rotation driving procedure to re-check the nip on the same roller or whether to perform rotation for allowing the main gear rotation driving procedure to check a nip on a next roller to be checked.

10. The method for checking a printing machine nip according to claim 7, wherein
the main gear rotation driving procedure performs rotation-driving sufficient for deleting nips before rotating the main gear by the angle calculated by the main gear rotation angle calculating procedure.
